(19) United States
(12) Patent Application Publication
(10) Pub. No.: US 2023/0413371 A1
(43) Pub. Date: Dec. 21, 2023

(54) SELECTION OF TRANSMISSION METHOD FOR SMALL DATA TRANSMISSION

(71) Applicant: NOKIA TECHNOLOGIES OY, ESPOO (FI)

(72) Inventors: Philippe GODIN, Versailles (FR); Alberto MARTÍNEZ-ALBA, Munich (DE); Daniela LASELVA, Klarup (DK); Subramanya CHANDRASHEKAR, Bangalore (IN); Srinivasan SELVAGANAPATHY, Bangalore (IN); Rakash SIVASIVA GANESAN, Unterhaching (DE)

(21) Appl. No.: 18/033,378

(22) PCT Filed: Jul. 7, 2021
(86) PCT No.: PCT/EP2021/068797

§ 371 Date: Apr. 24, 2023

(30) Foreign Application Priority Data
Oct. 22, 2020 (IN) 202041046087

(51) Int. Cl. H04W 76/27; H04W 48/16; H04W 12/106; H04W 12/04

(52) U.S. Cl. CPC H04W 76/27; H04W 12/04; H04W 12/106; H04W 48/16

(57) ABSTRACT

For performing a small data transmission triggered in an inactive state of a user equipment (S701, S703), a first transmission method or a second transmission method is selected at least based on a cell of a cellular communication system in which the small data transmission is to be performed by the user equipment (S705). Then the small data transmission is performed using the selected first or second transmission method (S707).

### TECHNICAL FIELD

At least some embodiments relate to apparatuses, methods and non-transitory storage media for selecting a transmission method, e.g., an RRC (Radio Resource Control) protocol method, for SDT (Small Data Transmission). For example, at least some embodiments relate to narrow band (NB)-Internet of Things (IoT) and SDT in RRC inactive state.

### BACKGROUND

A cellular communication system, e.g. a 5G NR system, enables small data transmissions (SDTs) when a UE is in an RRC inactive state.

For example, RRC-less SDT is currently limited for use in the same cell, which is the last serving cell for a UE in state “RRC Connected” before transitioning to state “RRC Inactive”, or for Configured Grant (CG) based SDT. Hence, RRC-less SDT may not be applied whenever the UE initiates an SDT procedure to a different cell than the last serving cell.

### CITATION LIST

3GPP TS 33.501
3GPP TS 36.331
3GPP TS 38.331
3GPP TS 38.401
3GPP TS 38.473

### LIST OF ABBREVIATIONS

3GPP Third Generation Partnership Project
AMF Access and Mobility Management Function
AS Access Stratum
CAG Closed Access Group
CCCH Common Control Channel
CE Control Element
CG Configured Grant
C-RNTI Connected Radio Network Temporary Identifier
CP Control Plane
CU Centralized Unit
DRB Data Radio Bearer
DU Distributed Unit
EIA EPS Integrity Algorithm
EPS Evolved Packet System
gNB 5G Node B
ID Identifier
IoT Internet of Things
IP Integrity Protection
I-RNTI Inactive Radio Network Temporary Identifier
MAC Medium Access Control
MAC-I Message Authentication Code for Integrity
NB Narrow Band
NCC Next-hop Chaining Count
NCGI NG-RAN CGI=NG-RAN Cell Global Identifier
NCI NR Cell Identifier
NG-RAN Next Generation—Radio Access Network
NIA NIDD Information Answer
NIDD Non-IP Data Delivery
NR New Radio
PDCP Packet Data Convergence Protocol
PDU Packet Data Unit
PUSCH Physical Uplink Shared Channel
RAN Radio Access Network
RNA RAN Notification Area
RANAC RAN Area Codes
RNAU RAN Notification Area Update
RRC Radio Resource Control protocol
SA Security Architecture
SDT Small Data Transmission
TAU Tracking Area Update
TEID Tunnel Endpoint Identifier
UE User Equipment
UP User Plane
Uu radio interface between UE and gNB
Xn Xn network interface

### Definitions

NR Cell Global Identifier (NCGI): used to identify NR cells globally. The NCGI is constructed from the PLMN identity the cell belongs to and the NR Cell Identity (NCI) of the cell.

gNB Identifier (gNB ID): used to identify gNBs within a PLMN. The gNB ID is contained within the NCI of its cells.

Global gNB ID: used to identify gNBs globally. The Global gNB ID is constructed from the PLMN identity the gNB belongs to and the gNB ID. The MCC and MNC are the same as included in the NCGI.

Global gNB ID=PLMN ID+gNB ID

Full I-RNTI: A full I-RNTI which has a length of 40 bits which can be included within a 64 bit RRCResumeRequest1 message over Common Control Channel 1

Short I-RNTI: A short I-RNTI which has a length of 24 bits which can be included within a 48 bit RRCResumeRequest message Common Control Channel

Last serving NG-RAN: node that stores the Inactive UE Context.

### SUMMARY

At least some example embodiments aim at enabling a UE to perform a dynamic selection between SDT transmission methods, e.g., an RRC-less SDT procedure and an RRC-based SDT procedure, in RRC Inactive, depending on a cell in which the UE is initiating such procedure, e.g. based on network assistance.

At least some example embodiments enable a smooth switching of a UE between transmission methods for an SDT procedure, e.g., RRC-less SDT and RRC-based SDT approaches, depending on the cell in which the UE initiates the SDT procedure.

According to at last some example embodiments, the UE is enabled to determine whether it is initiating an SDT procedure in the last serving gNB or not. According to at least some example embodiments, the last serving gNB is a node that stores a context of a UE that is in inactive state. As a result, RRC-less SDT can be applied not only to SDT procedures initiated in the last serving cell, but also in all the cells controlled by the UE's last serving CU-UP in the same gNB.

First, at least some example embodiments enable provisioning of cells/RAN areas to the UE where one or more properties of SDT transmissions may differ. Examples of such properties include the use of RRC-based vs. RRC-less method for SDT, or the application of UP IP.

Secondly, at least some example embodiments enable a dynamic switch at the UE between RRC-less and RRC-based SDT depending on the serving cell as well as based on other triggers (e.g. RRC-based selection triggered by a key change), resulting in extending the use of the RRC-less method, and in turn in decreasing Uu signaling overhead.

Moreover, at last some example embodiments work well with both basic routing and enhanced routing.

In the following, example embodiments will be described with reference to the accompanying drawings.

### BRIEF DESCRIPTION OF THE DRAWINGS

FIG. 1 shows a signaling diagram illustrating RRC Inactive operations for the same-cell scenario.

FIG. 2 shows signaling diagrams illustrating three SDT procedures a) to c).

FIG. 3 shows a schematic diagram illustrating content of a UL MAC PDU for SDT procedures for a baseline RRC-based method.

FIG. 4 shows a schematic diagram illustrating 5G-RAN distributed (left) and split CU-DU architecture (right) for both user plane (UP) and control plane (CP).

FIG. 5 shows a signaling diagram illustrating SDT operations in RRC Inactive for CU-DU split scenario for the case of RRC-based SDT.

FIG. 6 shows a signaling diagram illustrating enhanced stateless routing at DU for SDT operations in RRC Inactive for CU-DU split scenario for RRC-less SDT method.

FIG. 7 shows a flowchart illustrating a process 1 according to at least some example embodiments.

FIG. 8 shows a flowchart illustrating a process 2 according to at least some example embodiments.

FIG. 9 shows a signaling diagram illustrating signaling according to at least some example embodiments.

FIG. 10 shows a schematic block diagram illustrating a configuration of a control unit in which at least some example embodiments are implementable.

### DESCRIPTION OF THE EMBODIMENTS

At least some example embodiments are concerned with enhancements associated with Small Data Transmission (SDT) in RRC Inactive.

UE in RRC Inactive

An Inactive-RNTI (I-RNTI) identifier is allocated by the last serving gNB (also called anchor gNB in the following) to a UE that is being moved to an RRC Inactive state. The I-RNTI identifier is configured as part of an RRC release message with SuspendConfiguration, and the UE transmits it within an RRC resume request message. The I-RNTI includes means to identify both the UE and the last serving gNB, so it has to include a UE ID part and gNB ID part. The algorithm used to construct the I-RNTI by the network is specific to a network vendor and this includes decision on the position within the I-RNTI and number of bits used for UE ID and gNB ID parts. In fact, the 3GPP specifications do not specify the number of bits which should be used to identify the gNB and the number of bits which should be used to identify the UE within the total I-RNTI bits, nor the position of UE ID and anchor gNB ID parts within the I-RNTI.

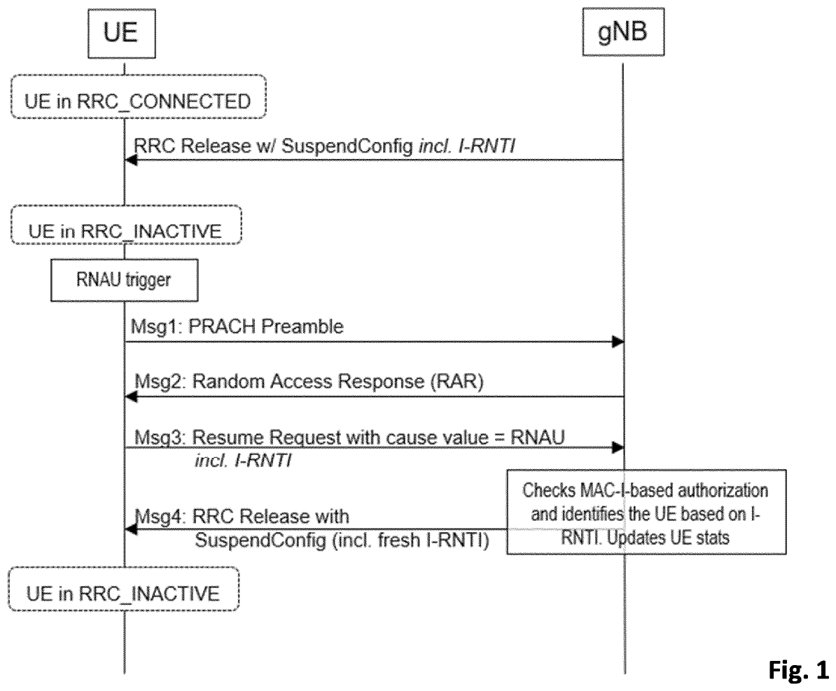

While in RRC Inactive, the UE can move within a pre-defined RAN Notification Area (RNA), composed of one or more cells, without notifying the network. If the UE enters a cell not included in the RNA, it needs to send an RNA update (RNAU), e.g. as illustrated in FIG. 1 which shows a signaling diagram related to RRC Inactive operations for the same-cell scenario in case the UE needs to send an RNA update. In addition, the RRC Inactive UE is also required to send periodic RNAUs similarly to the periodic TAU. This RNA can cover a single or multiple cell(s) and shall be contained within the CN registration area. The configuration of the RNA is shown below as from 3GPP TS 38.331.

| | |
|---|---|
| SuspendConfig ::= | SEQUENCE { |
| fullI-RNTI | I-RNTI-Value, |
| shortI-RNTI | ShortI-RNTI-Value, |
| ran-PagingCycle | PagingCycle, |
| ran-NotificationAreaInfo | RAN-NotificationAreaInfo |
| OPTIONAL, -- Need M | |
| t380 | PeriodicRNAU-TimerValue |
| OPTIONAL, -- Need R | |
| nextHopChainingCount | NextHopChainingCount, |

. . .
}
. . .

| | |
|---|---|
| PeriodicRNAU-TimerValue ::= | ENUMERATED { min5, min10, min20, min30, |

min60, min120, min360, min720}

| | |
|---|---|
| . . . | |
| RAN-NotificationAreaInfo ::= | CHOICE { |
| cellList | PLMN-RAN-AreaCellList, |
| ran-AreaConfigList | PLMN-RAN-AreaConfigList, |

. . .
}
. . .

SuspendConfig field descriptions

ran-NotificationAreaInfo
Network ensures that the UE in RRC_INACTIVE always has a valid ran-
NotificationAreaInfo.
ran-PagingCycle
Refers to the UE specific cycle for RAN-initiated paging. Value rf32 corresponds to
32 radio frames, value rf64 corresponds to 64 radio frames and so on.
t380
Refers to the timer that triggers the periodic RNAU procedure in UE. Value min5
corresponds to 5 minutes, value min 10 corresponds to 10 minutes and so on.

RAN-NotificationAreaInfo field descriptions

cellList
A list of cells configured as RAN area.
ran-AreaConfigList
A list of RAN area codes or RA code(s) as RAN area.

Small Data Transmission in RRC INACTIVE State

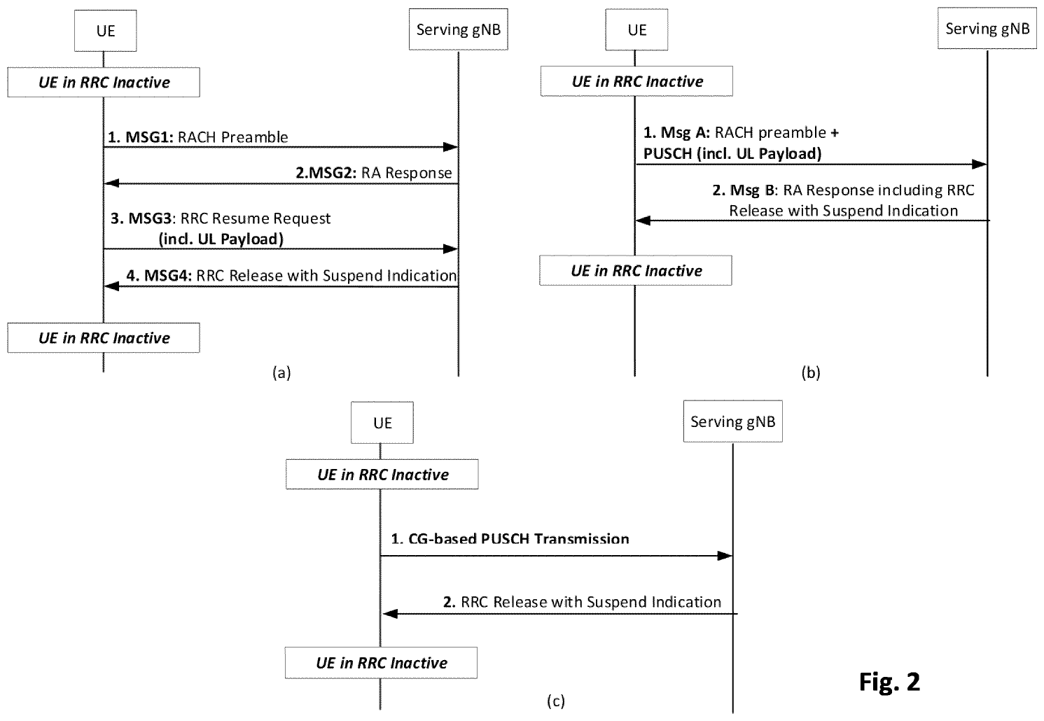

According to NR small data transmission in INACTIVE state, three procedures for enabling Small Data Transmission (SDT) in the Uplink in a 5G NR system are considered as illustrated in FIG. 2:
1. Procedure a): 4-step RACH based SDT: UP data transmitted in Msg3 of a 4-step RACH procedure (i.e. small payload multiplexed with an RRC Connection Resume Request in the same UL MAC PDU).
2. Procedure b): 2-step RACH based SDT: UP data transmission happens with MsgA of a 2-step RACH procedure and specifically on PUSCH resources that are pre-configured by the gNB and broadcast in System Information with associated physical transmission parameters.
3. Procedure c): Configured Grant based SDT: A UE in RRC_Connected state can receive a CG type1 configuration that indicates specific pre-configured PUSCH resources to be used for UL data transmission. This CG configuration can also be used in RRC_Inactive state as long as e.g. the timing alignment is valid.

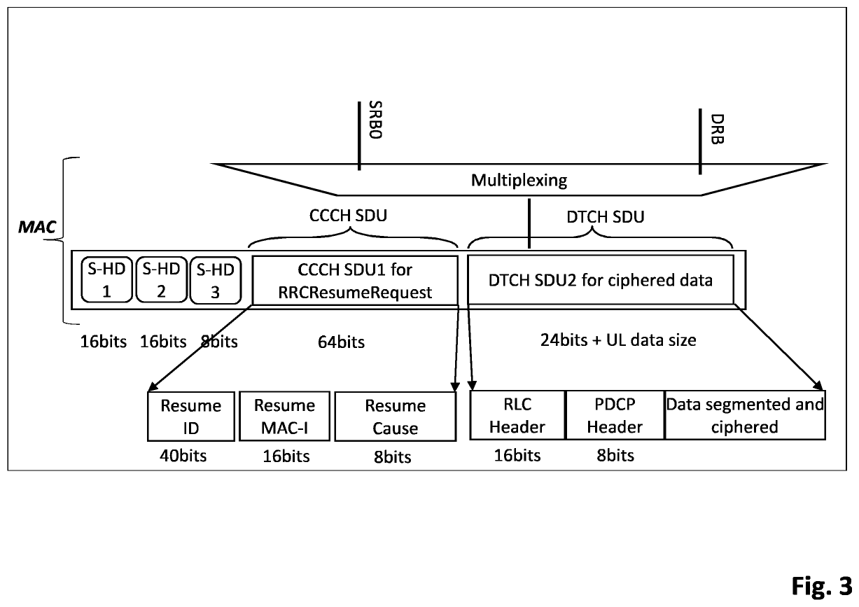

In FIG. 2, an RRC-based approach was assumed. It entails that the UE sends an RRC message including information about the UE identity and its authentication token (i.e. MAC-I). In FIG. 1, it is assumed that the RRC Resume Request message is used for this purpose. FIG. 3 shows a UL MAC PDU for SDT Msg3/MsgA or CG-based SDT transmission for the baseline RRC-based method.

Instead, the RRC-less approach assumes that the RRC layer need not be involved and the necessary information, such as UE identity and UE authentication token, can be provided by the UE e.g. in the MAC header or as a MAC CE.

Network Identities in 5G NR

In 5G NR, the following network identities are defined that are relevant according to at least some example embodiments:
NG-RAN CGI=NG-RAN Cell Global Identifier (NCGI) of a cell, that is used to globally identify a cell. It includes a PLMN ID and an NR Cell Identifier (NCI): NCGI=PLMN ID+NCI.
NCI is a 36-bit identity to identify the gNB (22-32 bits) and its local Cell Identity (14-4 bits) that is broadcasted (see CellIdentity in 3GPP TS 38.331): NCI=gNB ID+Cell ID
   NCI with 36 bits is in the range from 0 to 68.719.476.735;
   gNB ID with 32 bits is in the range from 0 to 4.294.967.295;
   Cell ID with 14 bits is from 0 to 16.383.

Security Aspects Relevant According to at Least Some Example Embodiments

When the UE attempts resuming, the RRCResumeRequest message shall include the I-RNTI for context identification and a MAC-I (i.e. the ResumeMAC-I/shortResumeMAC-I). The latter is a 16-bit message authentication token that the UE shall calculate using the integrity algorithm (NIA or EIA) in the stored AS security context, which was negotiated between the UE and the last serving gNB/ng-eNB, and the current K_{RRCint} with certain known inputs:

KEY: it shall be set to current KRRCint;

BEARER: all its bits shall be set to 1;

DIRECTION: its bit shall be set to 1;

COUNT: all its bits shall be set to 1;

MESSAGE: it shall be set to VarResumeMAC-Input/VarShortInactiveMAC-Input as defined in 3GPP TS 38.331 for gNB and in 3GPP TS 36.331 for ng-eNB with following inputs:
source PCI, target Cell-ID, source C-RNTI

Handling of the security keys at gNB and UE at the RRC state transitions from RRC Connected to Inactive is as per Section 6.8.2.1.2 of 3GPP TS 33.501.

Handling of the security keys at gNB and UE at the RRC state transitions to RRC Connected from RRC Inactive is as per Section 6.8.2.1.3 of 3GPP TS 33.501.

CU-DU Split Architecture

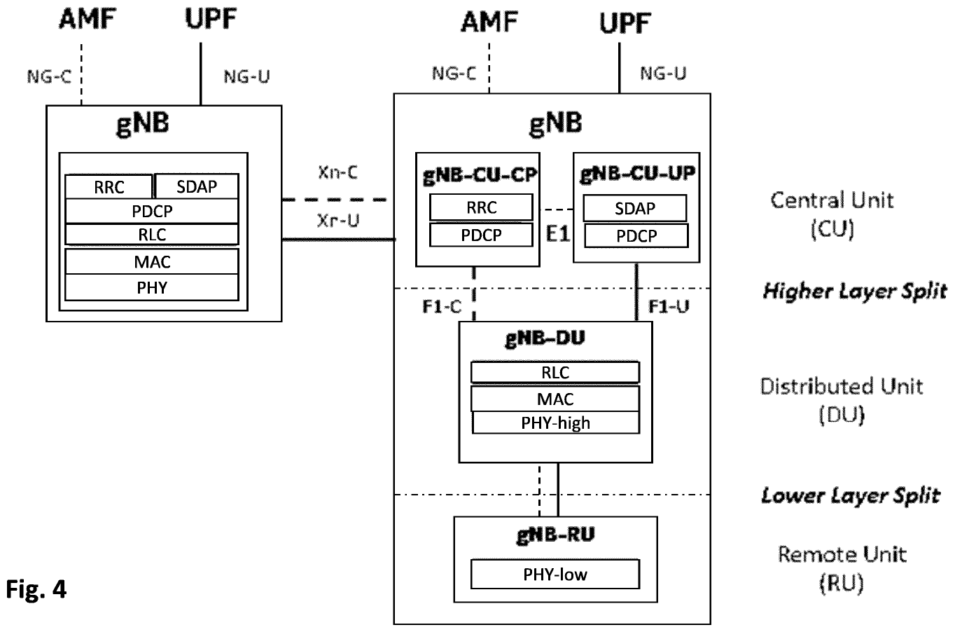

A RAN architecture split into centralized baseband units and distributed radio units has gained traction and has proven to be effective in commercial (3G/LTE) deployments over the past years. Such centralized architecture has both performance benefits (e.g. due to improved inter-cell coordination at the centralised baseband) and cost benefits (e.g. due to increased hardware/software pooling, reduced site rental and management costs). With the challenging and diverse requirements for NR systems, the need for such split RAN architecture has become ever more important. The NG-RAN architectures defined in NR are shown in FIG. 4. On the left, the distributed architecture shows a traditional gNB comprising all RAN protocol layers. On the right, it is shown the NG-RAN split architecture with a higher layer separation into a Central Unit (CU) controlling one or more of Distributed Units (DU) on the network side, which is supported in Rel-15 of the 5G-RAN system (3GPP TS 38.401). Such split architecture, where a function split is applied at one or more protocol layers at the network side, has potential for reduced cost, improved scalability, and more efficient scheduling coordination.

Assumptions Related to a UE in RRC INACTIVE in CU-DU Split Architecture

In the CU/DU split architecture, the following assumptions can be made for the gNB and cell that moves the UE to RRC Inactive state:
UE and CU-CP store the UE Context when UE moves into RRC_INACTIVE.
DU releases the stored UE context when UE moves into RRC_INACTIVE, and the corresponding F1-U tunnels established between DU and CU-UP.
CU-UP may retain the UE context in a suspended state when UE is in RRC_INACTIVE.

PDCP Security Context

Based on 3GPP Working Group SA3 input for UE in RRC_INACTIVE using the SDT mechanism, summarized in Table 1 below, the UE can use the stored PDCP security context (for data integrity protection, UE verification, and network verification), and it does not need an update of security parameters (such as ciphering keys or Next Chained Counter (NCC)) after an SDT procedure as long as the UE context is available (stored) and the PDCP entity is not relocated, i.e. case (1) and (2) in Table 1.

TABLE 1

| | | | (3) Different cell |
|---|---|---|---|
| | | | (than where the UE |
| | | | context is stored) |
| | | | and the cell is |
| | | (2) Same PDCP | ″covered″ by a |
| | | entity (e.g. PDCP | different PDCP entity |
| | (1) Same cell (where | entity is not | (e.g. PDCP entity is |
| Characteristics | UE context is stored) | relocated) | relocated) |
| (a) Data integrity | Recommended using | Recommended using | Recommended |
| protection | stored PDCP | stored PDCP | |
| | security context | security context | |
| (b) UE verification | Needed using stored | Needed using stored | Needed using stored |
| | PDCP security | PDCP security | PDCP security |
| | context | context | context |
| (c) Network | Needed using stored | Needed using stored | Needed using new |
| verification | PDCP security | PDCP security | PDCP security |
| | context | context | context |
| (d) New ciphering | Not needed | Not needed | Needed |
| key | | | |
| (f) Removing Msg5 | OK | OK | OK |
| (g) Msg3 integrity | Recommended | Recommended | Recommended with |
| protection | | | new key |
| (h) Integrity | Needed | Needed | Needed |
| protection of | | | |
| command to send | | | |
| UE into | | | |
| RRC_INACTIVE | | | |
| (change of | | | |
| state/configuration) | | | |

These conditions are valid whenever the gNB-CU-CP (hosting the RRC layer that stores the UE AS context) and the gNB-CU-UP (hosting the PDCP layer that stores the security context of the UE) have not changed for the UE. This means that—from a security perspective—the UE could initiate an RRC-less SDT in any cell which belongs to a DU controlled by the UE's last serving CU-CP and last serving CU-UP (i.e. in which the UE was in RRC Connected mode before transitioning to RRC Inactive).

However, currently the UE is unaware of the gNB (and gNB-CU-CP or gNB-CU-UP) to which a cell, broadcasting a certain 36-bit NR Cell Identity (NCI), belongs to/is associated with. This is because, the UE cannot discriminate between the gNB ID and Cell ID parts contained in the NCI since it does not know their lengths, as described above. Similarly, it is not aware of gNB-CU identifiers. Therefore, the UE is not capable to determine whether it is initiating a SDT procedure in the last serving gNB or not. As a result, with this limitation in place, the RRC-less SDT solution can be applied only to SDT procedures initiated in the last serving cell rather than the cells controlled by the UE's last serving CU-UP in the same gNB, which is a strong limitation.

Furthermore, it is not clear whether and how mobile UEs that could in principle perform SDT in a different cell, at one point or another, can make use of the RRC-less method as long as they are within the same serving gNB.

An additional observation, in light of Table 1, is that the UE authorization is needed even when initiating SDT in the same cell (1) or in a different cell without PDCP relocation (2). In Rel-15, such UE authorization, at a connection resume of an RRC Inactive UE, is based on a 16-bit MAC-I that is sent in the RRC Resume Request message, as described above. However, it is not useful to apply such authorization method for RRC-less SDT since it requires RRC involvement at both transmitter and receiver side, contradicting the aim of the RRC-less approach. Therefore, according to at least some example embodiments, it is assumed that the user plane integrity protection (UP IP) functionality is adopted for the RRC-less method. UP IP is an optional functionality of 5G NR, which is employed at PDCP layer (in CU-UP) as defined in 3GPP TS 33.501. A message authentication code (MAC-I/NAS-MAC) is generated using the integrity algorithm NIA and the message authentication code is then appended to the message when sent. UP Integrity protection is currently configured by RRC and is applicable to all PDUs of a DRB configured with UP IP. This means that currently, UP IP would have to be applied to all packets of a DRB configured with SDT irrespective of whether RRC-less SDT or RRC-based SDT approach is selected for the SDT transmission. However, using UP IP together with the RRC-based SDT approach would increase the Uu signaling overhead (i.e. two MAC-Is would have to be sent), which is undesired for small data use cases.

RRC-Based SDT in CU-DU Split Architecture

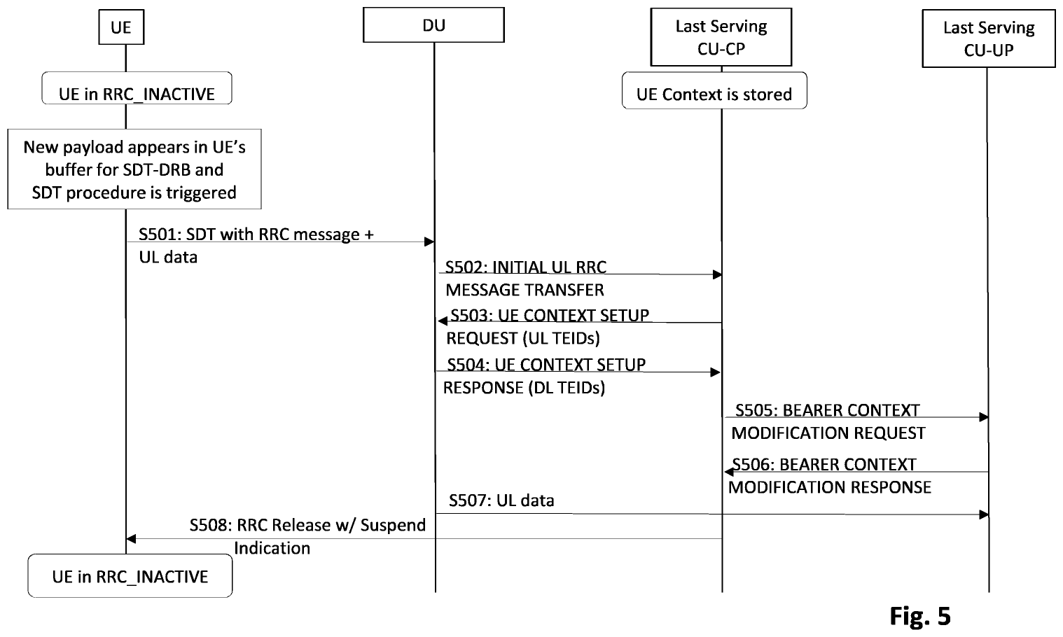

FIG. 5 shows a signaling diagram related to SDT operations in RRC Inactive for CU-DU split scenario for the case of RRC-based SDT.

As illustrated in FIG. 5, this approach entails that the DU extracts the UP data PDU from the MAC PDU included in the SDT transmission and the RRCResumeRequest message (if present) (step S501), which is forwarded to the CU-CP (within the message INITIAL UL RRC MESSAGE TRANSFER, see 3GPP TS 38.401) (S502).

Upon the reception of the RRCResumeRequest message (S502), the CU-CP verifies the identity of the UE, provides the appropriate TEIDs to the DU (S503) (via the message UE CONTEXT SETUP REQUEST), and sends the stored UE context to the CU-UP (S504-S506, see 3GPP TS 38.473) if the CU-UP does not store the UE context or a CU-UP change has taken place.

The DU then tunnels the data PDU to the CU-UP using the provided TEIDs (S507).

The CU-UP deciphers the message and forwards it to a UPF.

In step S508, the DU sends a message RRC Release with a Suspend Indication to the UE, upon which the UE enters the RRC Inactive state.

At least some example embodiments adopt the approach illustrated in FIG. 5, which will be described later on.

It is noted that it requires that the UE context is set up at the gNB-DU before the routing of the SDT UL payload can be made irrespective of which of RRC methods is adopted.

RRC-Less SDT in CU-DU Split Architecture

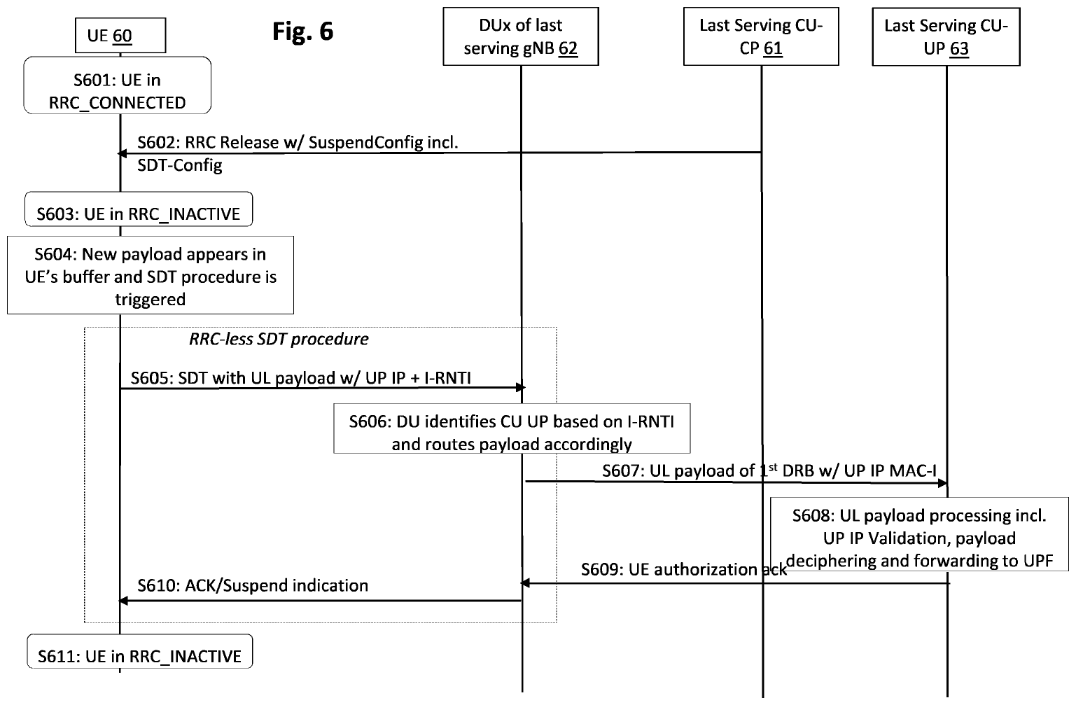

FIG. 6 shows a signaling diagram illustrating enhanced stateless routing at DU for SDT operations in RRC Inactive for CU-DU split scenario for RRC-less SDT method.

In S601, UE 60 is in RRC_Connected state.

In S602, last serving CU-CP 61, which has served the UE 60 in RRC_Connected, transmits a message “RRC Release” with field “SuspendConfig” including SDT-Configuration.

In S603, UE 60 has transitioned to RRC_Inactive state.

In S604, new payload appears in a buffer of UE 60 and SDT procedure is triggered.

In S605, the UE 60 performs SDT and transmits UL payload with UP IP and I-RNTI to a DU 62 of last serving gNB, according to an RRC-less SDT procedure.

In S606, the DU 62 identifies CU-UP 63 based on I-RNTI and routes the UL payload accordingly. That is, in S607, the DU 62 transmits UL payload of first DRB (SDT-DRB) with UP IP MAC-I to the last serving CU-UP 63.

In S608, the last serving CU-UP 63 processes the UL payload, including UP IP validation, payload deciphering and forwarding to UPF.

In S609, the last serving CU-UP 63 transmits an UE authorization acknowledgment to the DU 62.

In S610, DU 62 sends a response to UE 60 that may include an acknowledgment or suspend indication.

In S611, the UE 60 has entered RRC_Inactive state.

As described above, routing the UL payload is done without involvement of the CU-CP 61 and without storing of UE 60 context at DU 62, but simply routing the UL payload and the I-RNTI to the CU-UP 63 identified based on the I-RNTI. The approach is illustrated in FIG. 6 for the case of RRC-less SDT, where it is visible that it allows to avoid setting up a UE context at the gNB-DU 62 before routing the PDU from DU 62 to PDCP (CU-UP 63).

Such approach is used to complement at least some of the example embodiments as an alternative to the “baseline routing” in RAN split scenarios described above.

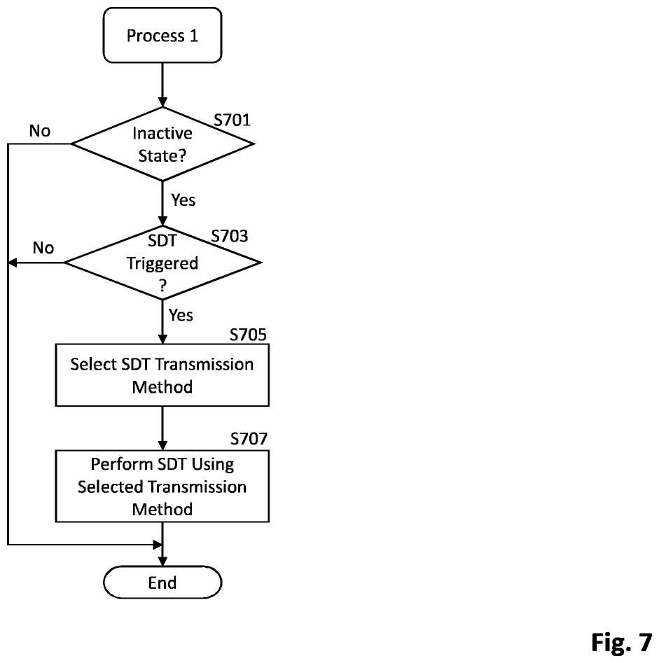

In the following, example embodiments will be described by referring to FIGS. 7 to 10.

FIG. 7 shows a flowchart illustrating a process 1 according to at least some example embodiments.

According to at least some example embodiments, process 1 is performed by a user equipment for use in a cellular communication system. According to at least some example embodiments, the user equipment comprises at least one processor and at least one memory including computer program code, the at least one memory and the computer program code configured to, with the at least one processor, cause the user equipment at least to perform process 1.

In step S701 of FIG. 7, it is determined whether or not the user equipment is in an inactive state with respect to a radio resource control, RRC, protocol (e.g. RRC_Inactive state). If No in step S701, process 1 ends.

Otherwise, if Yes in step S701, process 1 proceeds to step S703 in which it is determined whether or not a small data transmission is to be performed by the user equipment. If No in step S703, process 1 ends.

According to at least some example embodiments, in step S703 triggering of the small data transmission is determined according to e.g. any combination of data amount present in a buffer of the user equipment, an RSRP level, and other validity conditions that may apply.

Otherwise, if Yes in step S703, process 1 proceeds to step S705 in which a first transmission method or a second transmission method is selected for performing the small data transmission, at least based on a cell of the cellular communication system in which the small data transmission is to be performed by the user equipment. Then, process 1 proceeds to step S707.

In step S707, the small data transmission is performed using the selected first or second transmission method. Then process 1 ends.

According to at least some example embodiments, the first transmission method is based on the RRC protocol and the second transmission method is not based on the RRC protocol, i.e., without the RRC message carrying the payload.

According to at least some example embodiments, the second transmission method comprises stateless routing between a distributed unit and a centralized unit of a serving node of an access network of the cellular communication system, which controls the cell.

According to at least some example embodiments, also the first transmission method comprises stateless routing between a distributed unit and a centralized unit of a serving node of an access network of the cellular communication system, which controls the cell. In some examples, this is used depending on whether the UP IP is enabled for the first transmission method.

According to at least some example embodiments, in step S705 it is detected whether or not the cell in which the small data transmission is to be performed by the user equipment is controlled by a last serving node, wherein the last serving node is a node of an access network of the cellular communication system, which served the user equipment before it transited to the inactive state. In case the cell is controlled by the last serving node, the second transmission method is selected, and in case the cell is not controlled by the last serving node, the first transmission method is selected.

According to at least some example embodiments, in step S705 it is determined whether the cell in which the small data transmission is to be performed by the user equipment allows to use the second transmission method.

According to at least some example embodiments, information (e.g. a list, to be described in more detail later on with respect to embodiments 1 and 2) of cells or areas of the cellular communication system is acquired, wherein the information indicates that, for the small data transmission, the first or second transmission method is to be applied in the cells or areas, and in step S705 it is referred to the information for selecting the first or second transmission method.

According to at least some example embodiments, in step S705 it is detected whether or not the cell in which the small data transmission is to be performed by the user equipment is comprised in the information on areas acquired by the user equipment. In case the cell is comprised in the information of areas, the second transmission method is selected, and in case the cell is not comprised in the information on areas acquired by the user equipment, the first transmission method is selected.

According to at least some example embodiments, the information is acquired from at least one of the cellular communication system, the access network of the cellular communication system, and the last serving node.

According to at least some example embodiments, the information is acquired based on at least one of signaling related to RAN notification area provisioning, acquiring a configuration of the small data transmission, acquiring an RRC release message, acquiring a suspend configuration, and acquiring a broadcast message from the cell selected to perform the small data transmission.

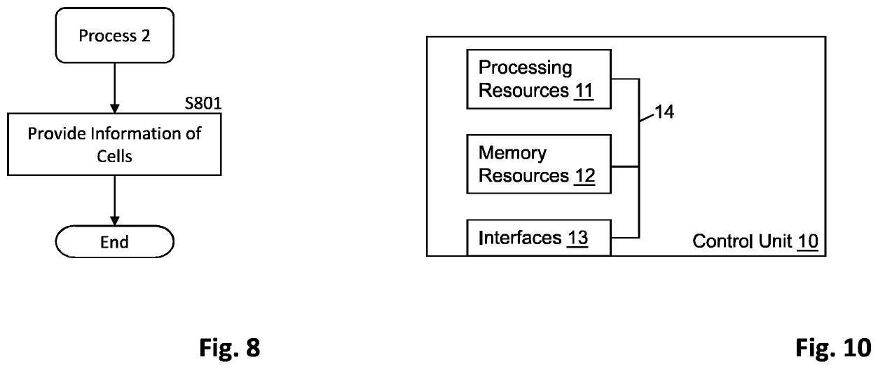

Now reference is made to FIG. 8 illustrating a flowchart of a process 2 according to at least some example embodiments.

According to at least some example embodiments, process 2 is performed by an apparatus for use in a cellular communication system.

According to at least some example embodiments, the apparatus comprises at least one processor and at least one memory including computer program code, the at least one memory and the computer program code configured to, with the at least one processor, cause the apparatus at least to perform process 2.

According to at least some example embodiments, the apparatus is part of an access network of the cellular communication system, and/or is a last serving node of a user equipment.

In step S801, information of cells or areas of the cellular communication system are provided, wherein the information indicates that, for a small data transmission to be performed by a user equipment in case the user equipment is in an inactive state, a first or second transmission method is to be applied in the cells or areas. Then process 2 ends.

According to at least some example embodiments, the information indicates the cells or areas of the cellular communication system, which are controlled by the last serving node.

According to at least some example embodiments, the information is provided based on at least one of signaling related to RAN notification area provisioning, acquiring a configuration of the small data transmission, acquiring an RRC release message and acquiring a suspend configuration.

According to at least some example embodiments, the information comprises at least one of cells or areas of the cellular communication system out of RAN notification areas configured in the user equipment, cell identifiers, area identifiers, RAN area code identifiers, tracking area identifiers, and closed area group identifiers.

Further, as a modification or supplement of FIG. 7 and/or FIG. 8, according to at least some example embodiments, it is decided at least based on the selected first or second transmission method, whether or not to use a protection function (e.g. UP Integrity protection (IP) function, to be described in more detail later on with respect to embodiments 1 and 2) which protects data integrity for a data radio bearer associated with the small data transmission.

According to at least some example embodiments, the deciding whether or not to use the protection function (e.g. user plane integrity protection function) also is based on an instruction acquired from the cellular communication system.

Further, as another modification or supplement of FIG. 7 and/or FIG. 8, which will be described in more detail later on with respect to embodiment 3, according to at least some example embodiments, in response to the small data transmission performed by the second transmission method in step S707, a request is provided from the cellular communication network to change a key used by the protection function, wherein the request is based on the first transmission method.

Alternatively or in addition, the second transmission method is switched to the first transmission method for performing the small data transmission after performing a predetermined number of small data transmissions by the second transmission method, and, in response to the switching, a request is provided from the cellular communication network to change a key used by the protection function, wherein the request is based on the first transmission method.

For example, the predetermined number is defined in specifications. Alternatively or in addition, the predetermined number is provided by the network.

### Embodiment 1

According to at least some example implementations of embodiment 1, a UE is configured to select and use the RRC-less SDT method as the second transmission method for SDT transmissions of an “SDT-DRB”, which is a DRB allowed to use SDT, to be initiated to any serving cell controlled by the last (i.e. same) gNB-CU-CP and same gNB-CU-UP (e.g. same gNB). It is noted that the data entitled to use SDT could be defined also on a different granularity/basis than DRB, such as QoS flow or alike.

It is noted that, according to at least some example implementations of embodiment 1, RRC-less SDT is applied while using either RACH-based SDT or CG-based SDT illustrated in FIG. 2.

UE Determination of Same Last Serving qNB Based on Network Assistance:

Option 1

The UE is provided by the network with a list of cells in which the RRC-less method should be applied. The network basically includes in this list the cells that belong to the same last serving gNB, in which it is feasible to apply RRC-less SDT.

Option 2

The provisioning of the list is implemented by extending signaling related to legacy RAN Notification Area (RNA) provisioning. For example, information is added to the cells/RANACs (RAN Area Codes) in the RNA, where the information is indicative of whether the RRC-less method should be applied or not in a cell/RANAC present in the RNA.

Basically, the UE is already configured with an RNA which is essentially a list of one or more RANAC IDs in the typical form. In this alternative, the UE is provided a list of RANAC IDs where the UE could perform RRC-less SDT.

For example, the cells eligible for RRC-less SDT form a subset of the UE's RNA.

In an example implementation, one bit in the RANAC ID indicates if it is eligible for RRC-less SDT.

Alternatively, a bitmap is added to the RNA configuration including the indices within the current RNA list of cells/RANACs that support the RRC-less SDT approach.

In another example implementation, two RNAs are configured to the UE, where the additional RNA, on top of the legacy RNA, includes the cells/RANACs that support the RRC-less SDT approach.

According to at least some example embodiments, the RANAC ID of a cell, enabling the UE to determine whether it can perform RRC-based SDT or RRC-less SDT, is broadcasted in the SIB of the cell, and this is read by INACTIVE UEs (e.g. UEs in RCC_Inactive state) for RNA updates (see also FIG. 1).

For example, one RANAC ID is represented by all cells of a DU (cloud deployment) or a gNB (classical deployment).

Option 3

The UE is provided by the network with a list of area identifiers which identifies the area within the RNA where it should use the RRC-less method. This can be a list of RANAC IDs, a list of Tracking Area IDs or a list of CAG IDs. Rationale for CAG IDs is that DU would typically connect to CU UPs associated with same slice in case of isolation.

Option 4

Any combination of the above options 1 to 3. To identify the area within the RNA where RRC-less can be used by the UE, the UE can be provided with a list of one of more RANAC ID(s), CAG ID(s), Tracking Area IDs, and cell IDs.

UP Integrity Protection (IP) Function at PDCP Transmitter for RRC-Less SDT

In one option, the UE is configured to enable UP IP for a PDU of an SDT-DRB, which is a DRB allowed to use SDT, if RRC-less SDT method is selected for transmitting the PDU and otherwise to disable UP IP (i.e. when RRC-based SDT method selected). To enable this option, two alternatives are proposed:

Alternative 1

The RRC layer of the UE sends an indication to the PDCP layer in the UE dynamically (e.g. on a per payload/PDU basis when SDT is triggered) relating to the selection of the RRC-less method, e.g. via an “IP UP enabled” indication.

Based on such indication, the PDCP UP IP function is applied accordingly when processing the PDU.

Alternative 2

Two paired DRBs are associated to an “SDT-DRB” (a DRB allowed to use SDT): a DRB1 configured without IP UP for RRC-based SDT method and a DRB2 configured with UP IP for RRC-less SDT.

The RRC layer of the UE sends an indication to e.g. the upper layer or the PDCP layer, to send a payload to the PDCP instance of DRB1 or DRB2 dynamically (e.g. on a per payload basis when SDT is triggered), based on the selection of the RRC method. If no indication, a default setting can be used (e.g. DRB2, UP IP enabled).

According to at least some example implementations of embodiment 1, the same UP IP setting is used to any UL SDT transmissions made within a given SDT procedure (e.g. in a multi-shot UL SDT procedure, which includes more than one UL SDT transmission).

### Embodiment 2

According to at least some example implementations of embodiment 2, a UE is configured to fallback to select the RRC-based SDT method for SDT transmissions of the SDT-DRB to be initiated in a serving cell that belongs to a different gNB-CU-CP and/or different gNB-CU-UP (e.g. different gNB).

UE Determination of Different Serving qNB:

The UE determines a different serving gNB similar to the above options 1-4 of embodiment 1.

UP Integrity Protection (IP) Function at PDCP Transmitter for RRC-Based SDT

Similar as with embodiment 1, it is assumed that the UE is configured to enable UP IP for a PDU of the SDT-DRB if RRC-less SDT method is selected for transmitting the PDU and otherwise to disable UP IP (i.e. when RRC-based SDT method selected).

Alternative 1

The UE is configured with disabling the user-plane integrity protection (UP IP) for a PDU of the SDT-DRB if RRC-based SDT method is selected for transmitting the PDU.

The RRC layer of the UE sends an indication to the PDCP layer in the UE dynamically (e.g. on a per payload basis when SDT is triggered) relating to the selection of the RRC-based method, e.g. via an “IP UP disabled” indication.

Based on such indication, the PDCP UP IP function is disabled accordingly when processing the PDU.

Alternative 2

Alternative 2 of embodiment 2 is similar to alternative 2 of embodiment 1.

Further Option

The UE is configured to enable UP IP for the PDUs of the SDT-DRB for both RRC-less SDT and RRC-based SDT method, when both methods are used dynamically in the network. The RRC-less SDT solution brings dual performance benefits, namely signaling optimization and faster SDT packet delivery to PDCP at the receiver side, without the need of communication with the CU-CP. According to this further option, then also the RRC-based SDT solution is enhanced, using UP IP as well, which allows to avoid setting up a UE context at the gNB-DU before routing the PDU to PDCP (CU-UP) if stateless routing is performed by the DU as described later. In turn, it allows to obtain a faster SDT packet delivery to PDCP at the receiver side, without the need of communication with the CU-CP, similarly to the RRC-less method.

### Embodiment 3: Enabling UP IP Key Change for RRC-Less SDT

The key change is a network decision based on different factors including change of PDCP anchor point and number of packets (PDCP count). According to at least some example implementations of embodiment 3, the network side decides to assign new UP-IP and IP-Integration keys (e.g. KintUP) after a maximum number of SDT transmissions that re-used the same key. For this case, in response to an RRC-less-SDT uplink transmission, the gNB can indicate the UE to use a new key. For example, the gNB does this by sending NH (Next-Chain Hopping) count (NCC) value via e.g. an RRC message.

Alternative 1

According to alternative 1, in response to an RRC-less SDT transmission, the network sends an RRC message configuring the key change to be used for subsequent RRC-less SDTs. According to an example implementation, a message such as Msg4 as shown in procedure (a) in FIG. 2, sent in response to an uplink SDT, contains an RRC message carrying new key values. For example, the CU-UP of the gNB receiving an N-th SDT UL data packet for the UE informs the CU-CP of the gNB to send an RRC message as response in this case, where N is the maximum number.

Alternative 2

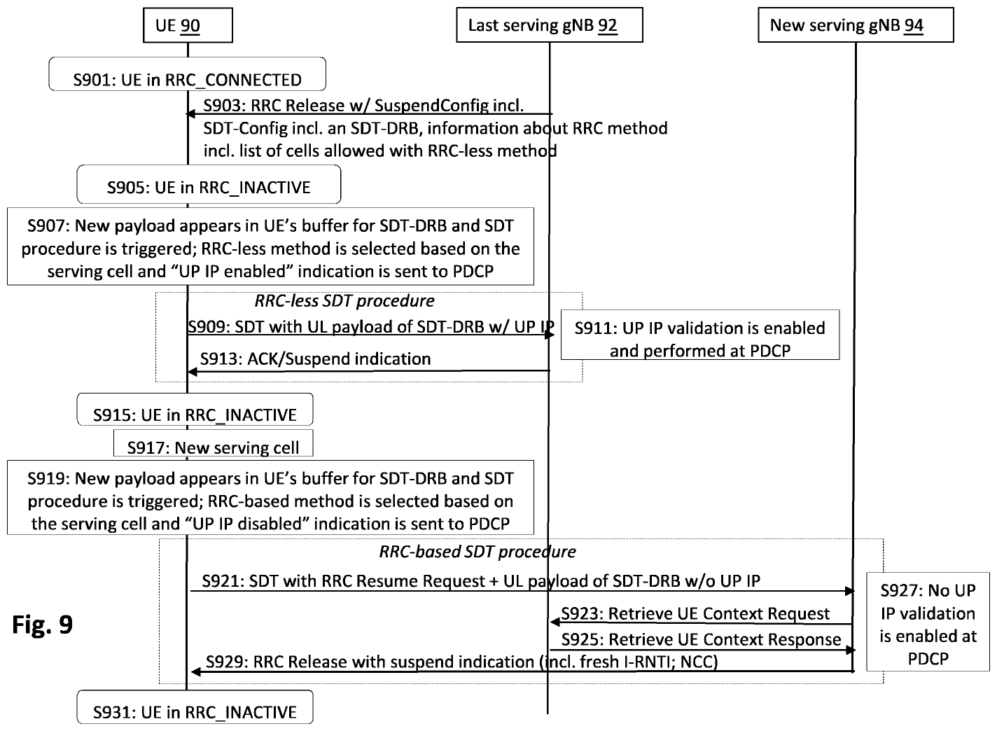

According to alternative 2, the UE is configured to switch to RRC-based SDT after performing N SDT transmissions or N SDT transactions, which enables the network to configure the key change via an RRC message. For example, the UE is configured to enable UP IP also for this RRC-based SDT transmission as the UL payload is to be processed by the same CU-UP (same PDCP instance), which is configured to perform UP IP validation, which will be described in more detail with reference to FIG. 9.

### Example Embodiment

FIG. 9 shows a signaling diagram according to an example embodiment for the case without RAN split architecture, i.e., in case of gNB deployment.

In S901, UE 90 is in RRC_Connected state.

In S903, last serving gNB 92, which has served the UE 90 in RRC_Connected, transmits a message “RRC Release” with field “SuspendConfig” including SDT configuration. The SDT configuration includes information about a transmission method for SDT, e.g. an RRC method. For example, the information includes a list of cells allowed with RRC-less SDT method.

In S905, in response to step S903, the UE 90 has transitioned to RRC_Inactive state.

In S907, new payload appears in a buffer of UE 90 for an SDT-DRB and SDT procedure is triggered. RRC-less method is selected based on the serving cell and “UP IP enabled” indication is sent to PDCP.

In S909, the UE 90 performs SDT and transmits UL payload of the SDT-DRB with UP IP to the last serving gNB 92, according to the RRC-less SDT procedure.

As shown by S911, UP IP validation is enabled and performed at PDCP.

Besides, the last serving gNB 92 processes the UL payload, including UP IP validation, payload deciphering and forwarding to UPF.

In S913, the last serving gNB 92 sends an acknowledgment or suspend indication to UE 90.

In reaction to the suspend indication, in S915, the UE 90 has entered RRC_Inactive state.

In S917, the UE enters a new serving cell.

In S919, new payload appears in the buffer of UE 90 for the SDT-DRB and SDT procedure is triggered. RRC-based method is selected based on the serving cell and “UP IP disabled” indication is sent to PDCP.

In S921, the UE 90 performs SDT with an RRC Resume Request and UL payload of the SDT-DRB without UP IP to a new serving gNB 94, according to the RRC-based SDT procedure.

In steps S923 and S925, the new serving gNB 94 retrieves the UE context from the last serving gNB 92.

As shown by S927, no UP IP validation is enabled or performed at PDCP.

In step S929, the new serving gNB 94 sends a message RRC release with suspend indication, including fresh I-RNTI and NCC.

In response to receiving this message, in step S931 the UE 90 switches into RRC_Inactive state.

When RAN split architecture is considered, according to at least some example embodiments:
Baseline DU to CU routing can be used for RRC-based SDT, as shown in FIG. 5, and
Enhanced stateless DU routing can be used for RRC-less SDT, as shown in FIG. 6.

According to DU routing, assuming the above routing strategy, upon SDT transmission reception, the DU checks whether the RRC-less or RRC-based SDT method has been used by inspecting a received MAC PDU.

If the MAC PDU does not contain the RRCResumeRequest message (or alike RRC message for SDT), the DU extracts the PDCP PDU and tunnels it to the CU-UP by applying enhanced stateless routing (i.e. without establishing the UE context in the DU but simply routing the user plane part to CU UP directly (e.g. identifying the CU-UP using certain bits of the UE ID part of the I-RNTI).

If the MAC PDU does contain the RRCResumeRequest message (or alike RRC message for SDT), the DU extracts both the PDCP PDU and RRC message (the latter is sent to the CU-CP). The DU tunnels the PDCP PDU to the CU-UP using the baseline routing (i.e. establishing the UE context in the DU first, see FIG. 5).

For example, for the case of embodiment 3, option 2, where RRC-based SDT is applied for security reasons despite the CU-UP being the same, the enhanced routing is applied also to such transmission. The CU-CP can instruct the DU to perform enhanced routing in its response to the DU.

With respect to UP Integrity protection (IP) verification function at the PDCP receiver side, the PDCP receiver is required to be aware of whether UP IP is enabled or not for a UE's DRB to properly configure the associated PDCP entity and process the PDUs. However, whether UP IP is applied or not at the PDCP instance corresponding to the UE's DRB in a given CU-UP is assumed to be a static setting here. Such setting can be configured by the RRC (CU-CP) to the PDCP (CP-UP) and can be based on the adopted RRC method to be used towards such CU-UP since the RRC-less SDT method implies UP IP, whereas the RRC-based SDT method implies no UP IP. In turn, such static setting on UP IP can be associated to the routing method used for routing the PDUs of the UE's DRB. It is noted that for a given CU-UP (PDCP) only one routing type can be used for a UE. Specifically, UP IP verification is applied for the UE's DRB at the last serving CU-UP of the UE, which uses stateless routing; on the contrary, no UP IP validation is configured for the UE's DRB in a newly established CU-UP for the UE, where the baseline routing is applied. We note also that after the current SDT procedure involving a new CU-UP is complete, such CU-UP becomes the last serving CU-UP and the next SDT procedure of the UE in the same CU-UP will be able to use the RRC-less SDT procedure, the stateless routing, and the UP IP validation. For the latter, after the current SDT procedure is complete, the new CU-UP needs to update the UP IP setting for the UE's DRB (i.e. to enable UP IP). This may need a PDCP re-establishment e.g. triggered by the CU-CP. Alternatively or additionally, the CU-CP indicates to the DU during F1 setup whether UP IP is enabled or not for a given UE.

Then, if UP IP validation is applied, the PDCP in the CU-UP performs deciphering and integrity verification of the PDCP Data PDU, and then forwards it to the UPF. Otherwise (if UP IP validation is not applied), the PDCP performs deciphering of the PDCP Data PDU, and then forwards it to the UPF.

As an additional aspect, the network configures the UE on whether UP IP is applied or not to a DL SDT transmission that is performed subsequently to the first UL SDT transmission.

Now reference is made to FIG. 10 illustrating a simplified block diagram of a control unit 10 that is suitable for use in practicing at least some example embodiments. According to an example implementation, process 1 of FIG. 7 is implemented by a control unit having the arrangement of the control unit 10, and process 2 of FIG. 8 is implemented by another control unit having the arrangement of the control unit 10.

The control unit 10 comprises processing resources (e.g. processing circuitry) 11, memory resources (e.g. memory circuitry) 12 and interfaces (e.g. interface circuitry) 13, which are coupled via a wired or wireless connection 14.

According to an example implementation, the memory resources 12 are of any type suitable to the local technical environment and are implemented using any suitable data storage technology, such as semiconductor based memory devices, magnetic memory devices and systems, optical memory devices and systems, fixed memory and removable memory. The processing resources 11 are of any type suitable to the local technical environment, and include one or more of general purpose computers, special purpose computers, microprocessors, digital signal processors (DSPs) and processors based on a multi core processor architecture, as non limiting examples.

According to an implementation example, the memory resources 12 comprise one or more non-transitory computer-readable storage media which store one or more programs that when executed by the processing resources 11 cause the control unit 10 to execute process 1 or 2.

Further, as used in this application, the term “circuitry” refers to one or more or all of the following:
(a) hardware-only circuit implementations (such as implementations in only analog and/or digital circuitry) and
(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and
(c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

In general, user equipments comprise, but are not limited to, mobile stations, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

According to at least some example embodiments, a user equipment for use in a cellular communication system is provided. The user equipment comprises means for determining a triggering of a small data transmission in an inactive state of the user equipment, means for selecting a first transmission method or a second transmission method for performing the small data transmission at least based on a cell of the cellular communication system in which the small data transmission is to be performed by the user equipment, and means for performing the small data transmission using the selected first or second transmission method.

According to at least some example embodiments, the first transmission method is based on a radio resource control, RRC, protocol and the second transmission method is not based on the RRC protocol.

According to at least some example embodiments, the means for selecting comprises means for detecting whether or not the cell in which the small data transmission is to be performed by the user equipment is controlled by a last serving node, wherein the last serving node is a node of an access network of the cellular communication system, which served the user equipment before it transited to the inactive state, and means for, in case the cell is controlled by the last serving node, selecting the second transmission method, and in case the cell is not controlled by the last serving node, selecting the first transmission method.

According to at least some example embodiments, the use equipment further comprises means for acquiring information of cells or areas of the cellular communication system, wherein the information indicates that, for the small data transmission, the first or second transmission method is to be applied in the cells or areas, and means for referring to the information for selecting the first or second transmission method.

According to at least some example embodiments, the information indicates the cells or areas of the cellular communication system, which are controlled by a last serving node, wherein the last serving node is a node of an access network of the cellular communication system, which served the user equipment before it transited to the inactive state.

According to at least some example embodiments, the means for acquiring comprises at least one out of the following:
means for acquiring the information from the cellular communication system;
means for acquiring the information from an access network of the cellular communication system;
means for acquiring the information based on signaling related to radio access network, RAN, notification area provisioning;
means for acquiring the information from the cell in which the small data transmission is to be performed by the user equipment;
means for acquiring the information from a last serving node which is a node of an access network of the cellular communication system, which served the user equipment before it transited to the inactive state;
means for acquiring the information in connection with acquiring a configuration of the small data transmission;
means for acquiring the information in connection with acquiring an RRC release message;
means for acquiring the information in connection with acquiring a suspend configuration.

According to at least some example embodiments, at least one out of the following applies:
the information indicates cells or areas of the cellular communication system out of RAN notification areas configured in the user equipment;
the information comprises cell identifiers;
the information comprises area identifiers;
the information comprises RAN area code identifiers;
the information comprises tracking area identifiers;
the information comprises closed area group identifiers;
the information comprises cell identifiers wherein a cell identifier identifies all cells of a serving node which controls the cells;
the information comprises area identifiers wherein an area identifier identifies all areas of a serving node which controls the areas.

According to at least some example embodiments, the means for selecting comprises means for detecting whether or not the cell in which the small data transmission is to be performed by the user equipment is comprised in the information on areas acquired by the user equipment, and means for, in case the cell is comprised in the information of areas, selecting the second transmission method, and in case the cell is not comprised in the information on areas acquired by the user equipment, selecting the first transmission method.

According to at least some example embodiments, the user equipment further comprises means for deciding, at least based on the selected first or second transmission method, whether or not to use a protection function which protects data integrity for a data radio bearer associated with the small data transmission.

According to at least some example embodiments, the means for deciding comprises means for deciding also based on an instruction acquired from the cellular communication system, whether or not to use the protection function.

According to at least some example embodiments, the user equipment further comprises means for sending an indication from a radio resource control, RRC, protocol layer of the user equipment to a packet data convergence protocol, PDCP, layer of the user equipment, to apply or not apply the protection function based on a decision whether or not to use the protection function.

According to at least some example embodiments, the user equipment further comprises means for, based on a decision whether or not to use the protection function,
sending an indication from a radio resource control, RRC, protocol layer of the user equipment to a first entity of a packet data convergence protocol, PDCP, layer of the user equipment, wherein the first entity is associated with a data radio bearer without integrity protection for which the protection function is not applied, wherein the data radio bearer without integrity protection is associated with the small data transmission, or
sending an indication from the RRC protocol layer of the user equipment to a second entity of the PDCP layer of the user equipment, wherein the second entity is associated with a data radio bearer with integrity protection for which the protection function is applied, wherein the data radio bearer with integrity protection is associated with the small data transmission.

According to at least some example embodiments, the means for sending comprises:
means for sending the indication on a per payload or packet data unit basis within the small data transmission, or
means for sending the indication for the small data transmission.

According to at least some example embodiments, the means for deciding comprises at least one of the following:
means for deciding to use the protection function in case the second transmission method is selected and deciding not to use the protection function in case the first transmission method is selected;
means for deciding to use the protection function in case the first or second transmission method is selected.

According to at least some example embodiments, the user equipment further comprises:
means for receiving, in response to the small data transmission performed by the second transmission method, a request from the cellular communication network to change a key used by the protection function, wherein the request is based on the first transmission method; or
means for switching the second transmission method to the first transmission method for performing a subsequent small data transmission after performing a predetermined number of small data transmissions by the second transmission method, and means for, in response to the switching, receiving a request from the cellular communication network to change a key used by the protection function, wherein the request is based on the first transmission method.

According to at least some example embodiments, an apparatus for use in a cellular communication system is provided. The apparatus comprises means for providing information of cells or areas of the cellular communication system, wherein the information indicates that, for a small data transmission to be performed by a user equipment in case the user equipment is in an inactive state, a first or second transmission method is to be applied in the cells or areas.

According to at least some example embodiments, the apparatus is a serving node of an access network of the cellular communication system, which controls the cell.

According to at least some example embodiments, the apparatus comprises a distributed unit and a centralized unit.

According to at least some example embodiments, the second transmission method comprises stateless routing between the distributed unit and the centralized unit.

According to at least some example embodiments, the means for providing comprises at least one of the following:
means for providing the information based on signaling related to radio access network, RAN notification area provisioning;
means for providing the information in connection with providing a configuration of the small data transmission;
means for providing the information in connection with providing an RRC release message;
means for providing the information in connection with providing a suspend configuration.

According to at least some example embodiments, at least one out of the following applies:
the apparatus is a last serving node which is a node of an access network of the cellular communication system, which served the user equipment before it transited to the inactive state,
the information indicates cells or areas of the cellular communication system out of RAN notification areas configured in the user equipment;
the information comprises cell identifiers;
the information comprises area identifiers;
the information comprises RAN area code identifiers;
the information comprises tracking area identifiers;
the information comprises closed area group identifiers;
the information comprises cell identifiers wherein a cell identifier identifies all cells of a serving node which controls the cells;
the information comprises area identifiers wherein an area identifier identifies all areas of a serving node which controls the areas.

According to at least some example embodiments, the apparatus further comprises means for providing an instruction to the user equipment whether or not to use a protection function which protects data integrity for a data radio bearer associated with the small data transmission.

According to at least some example embodiments, the instruction is associated with the first or second transmission method which is to be applied in the cells or areas.

According to at least some example embodiments, the apparatus further comprises:
means for transmitting, in response to the small data transmission performed by the second transmission method, a request to the user equipment to change a key used by the protection function, using the first transmission method; or
means for transmitting, in response to the user equipment switching the second transmission method to the first transmission method for performing the small data transmission after performing a predetermined number of small data transmissions by the second transmission method, a request to the user equipment to change a key used by the protection function, using the first transmission method.

It is to be understood that the above description is illustrative of the invention and is not to be construed as limiting the invention. Various modifications and applications may occur to those skilled in the art without departing from the true spirit and scope of the invention as defined by the appended claims.

1. A user equipment for use in a cellular communication system, the user equipment comprising:
at least one processor; and
at least one memory including computer program code, the at least one memory and the computer program code configured to, with the at least one processor, cause the user equipment at least to perform:
determining a triggering of a small data transmission in an inactive state of the user equipment;
selecting a first transmission method or a second transmission method for performing the small data transmission at least based on a cell of the cellular communication system in which the small data transmission is to be performed by the user equipment; and
performing the small data transmission using the selected first or second transmission method.

2. The user equipment of claim 1, wherein the first transmission method is based on a radio resource control, RRC, protocol and the second transmission method is not based on the RRC protocol.

3. The user equipment of claim 1, the selecting comprising
detecting whether or not the cell in which the small data transmission is to be performed by the user equipment is controlled by a last serving node, wherein the last serving node is a node of an access network of the cellular communication system, which served the user equipment before it transited to the inactive state; and
in case the cell is controlled by the last serving node, selecting the second transmission method, and in case the cell is not controlled by the last serving node, selecting the first transmission method.

4. The user equipment of claim 1, wherein the at least one memory and the computer program code are configured to, with the at least one processor, cause the user equipment to further perform:
acquiring information of cells or areas of the cellular communication system, wherein the information indicates that, for the small data transmission, the first or second transmission method is to be applied in the cells or areas; and
referring to the information for selecting the first or second transmission method.

5. The user equipment of claim 4, wherein the information indicates the cells or areas of the cellular communication system, which are controlled by a last serving node, wherein the last serving node comprises a node of an access network of the cellular communication system, which served the user equipment before it transited to the inactive state.

6. The user equipment of claim 4, the acquiring comprising at least one out of the following:
acquiring the information from the cellular communication system;
acquiring the information from an access network of the cellular communication system;
acquiring the information based on signaling related to radio access network, RAN, notification area provisioning;
acquiring the information from the cell in which the small data transmission is to be performed by the user equipment;
acquiring the information from a last serving node which is a node of an access network of the cellular communication system, which served the user equipment before it transited to the inactive state;
acquiring the information in connection with acquiring a configuration of the small data transmission;
acquiring the information in connection with acquiring an RRC release message;
acquiring the information in connection with acquiring a suspend configuration,
wherein at least one out of the following applies:
the information indicates cells or areas of the cellular communication system out of RAN notification areas configured in the user equipment;
the information comprises cell identifiers;
the information comprises area identifiers;
the information comprises RAN area code identifiers;
the information comprises tracking area identifiers;
the information comprises closed area group identifiers;
the information comprises cell identifiers wherein a cell identifier identifies all cells of a serving node which controls the cells; or
the information comprises area identifiers wherein an area identifier identifies all areas of a serving node which controls the areas.

7. The user equipment of claim 4, the selecting comprising:
detecting whether or not the cell in which the small data transmission is to be performed by the user equipment is comprised in the information on areas acquired by the user equipment; and
in case the cell is comprised in the information of areas, selecting the second transmission method, and in case the cell is not comprised in the information on areas acquired by the user equipment, selecting the first transmission method.

8. The user equipment of claim 1, wherein the at least one memory and the computer program code are configured to, with the at least one processor, cause the user equipment to further perform:
deciding, at least based on the selected first or second transmission method, whether or not to use a protection function which protects data integrity for a data radio bearer associated with the small data transmission.

9. The user equipment of claim 8, the deciding comprising:
deciding based on an instruction acquired from the cellular communication system, whether or not to use the protection function.

10. The user equipment of claim 8, wherein the at least one memory and the computer program code are configured to, with the at least one processor, cause the user equipment to further perform:
sending an indication from a radio resource control, RRC, protocol layer of the user equipment to a packet data convergence protocol, PDCP, layer of the user equipment, to apply or not apply the protection function based on a decision whether or not to use the protection function.

11. The user equipment of claim 8, wherein the at least one memory and the computer program code are configured to, with the at least one processor, cause the user equipment to further perform:
based on a decision whether or not to use the protection function,
sending an indication from a radio resource control, RRC, protocol layer of the user equipment to a first entity of a packet data convergence protocol, PDCP, layer of the user equipment, wherein the first entity is associated with a data radio bearer without integrity protection for which the protection function is not applied, wherein the data radio bearer without integrity protection is associated with the small data transmission, or
sending an indication from the RRC protocol layer of the user equipment to a second entity of the PDCP layer of the user equipment, wherein the second entity is associated with a data radio bearer with integrity protection for which the protection function is applied, wherein the data radio bearer with integrity protection is associated with the small data transmission.

12. The user equipment of claim 10, the sending comprising:
sending the indication on a per payload or packet data unit basis within the small data transmission, or
sending the indication for the small data transmission.

13. The user equipment of claim 8, the deciding comprising at least one of the following:
deciding to use the protection function in case the second transmission method is selected and deciding not to use the protection function in case the first transmission method is selected;
deciding to use the protection function in case the first or second transmission method is selected.

14. The user equipment of claim 8, wherein the at least one memory and the computer program code are configured to, with the at least one processor, cause the user equipment to further perform at least one of the following:
receiving, in response to the small data transmission performed by the second transmission method, a request from the cellular communication network to change a key used by the protection function, wherein the request is based on the first transmission method; or
switching the second transmission method to the first transmission method for performing a subsequent small data transmission after performing a predetermined number of small data transmissions by the second transmission method, and, in response to the switching, receiving a request from the cellular communication network to change a key used by the protection function, wherein the request is based on the first transmission method.

15. An apparatus for use in a cellular communication system, the apparatus comprising:
at least one processor; and
at least one memory including computer program code, the at least one memory and the computer program code configured to, with the at least one processor, cause the apparatus at least to perform:
providing information of cells or areas of the cellular communication system, wherein the information indicates that, for a small data transmission to be performed by a user equipment in case the user equipment is in an inactive state, a first or second transmission method is to be applied in the cells or areas.

16. The apparatus of claim 15, wherein
the apparatus comprises a serving node of an access network of the cellular communication system, which controls the cell,
the apparatus comprises a distributed unit and a centralized unit, and wherein
the second transmission method comprises stateless routing between the distributed unit and the centralized unit.

17. The apparatus of claim 15, the providing comprising at least one of the following:
providing the information based on signaling related to radio access network, RAN notification area provisioning;
providing the information in connection with providing a configuration of the small data transmission;
providing the information in connection with providing an RRC release message;
providing the information in connection with providing a suspend configuration,
wherein at least one out of the following applies:
the apparatus is a last serving node which is a node of an access network of the cellular communication system, which served the user equipment before it transited to the inactive state,
the information indicates cells or areas of the cellular communication system out of RAN notification areas configured in the user equipment;
the information comprises cell identifiers;
the information comprises area identifiers;
the information comprises RAN area code identifiers;
the information comprises tracking area identifiers;
the information comprises closed area group identifiers;
the information comprises cell identifiers wherein a cell identifier identifies all cells of a serving node which controls the cells; or
the information comprises area identifiers wherein an area identifier identifies all areas of a serving node which controls the areas.

18. The apparatus of claim 15, wherein the at least one memory and the computer program code are configured to, with the at least one processor, cause the apparatus to further perform:
providing an instruction to the user equipment whether or not to use a protection function which protects data integrity for a data radio bearer associated with the small data transmission.

19. The apparatus of claim 18, wherein the instruction is associated with the first or second transmission method which is to be applied in the cells or areas.

20. The apparatus of claim 15, wherein the at least one memory and the computer program code are configured to, with the at least one processor, cause the apparatus to further perform at least one of the following:
transmitting, in response to the small data transmission performed by the second transmission method, a request to the user equipment to change a key used by the protection function, using the first transmission method; or
transmitting, in response to the user equipment switching the second transmission method to the first transmission method for performing the small data transmission after performing a predetermined number of small data transmissions by the second transmission method, a request to the user equipment to change a key used by the protection function, using the first transmission method.

21. A method for use by a user equipment for use in a cellular communication system, the method comprising:
determining a triggering of a small data transmission in an inactive state of the user equipment;
selecting a first transmission method or a second transmission method for performing the small data transmission at least based on a cell of the cellular communication system in which the small data transmission is to be performed by the user equipment; and
performing the small data transmission using the selected first or second transmission method.

22. The method of claim 21, wherein the first transmission method is based on a radio resource control, RRC, protocol and the second transmission method is not based on the RRC protocol.

23. The method of claim 21, the selecting comprising:
detecting whether or not the cell in which the small data transmission is to be performed by the user equipment is controlled by a last serving node, wherein the last serving node is a node of an access network of the cellular communication system, which served the user equipment before it transited to the inactive state; and
in case the cell is controlled by the last serving node, selecting the second transmission method, and in case the cell is not controlled by the last serving node, selecting the first transmission method.

24. The method of claim 21, further comprising:
acquiring information of cells or areas of the cellular communication system, wherein the information indicates that, for the small data transmission, the first or second transmission method is to be applied in the cells or areas; and
referring to the information for selecting the first or second transmission method.

25. The method of claim 24, wherein the information indicates the cells or areas of the cellular communication system, which are controlled by a last serving node, wherein the last serving node is a node of an access network of the cellular communication system, which served the user equipment before it transited to the inactive state.

26. The method of claim 24, the acquiring comprising at least one out of the following:
acquiring the information from the cellular communication system;
acquiring the information from an access network of the cellular communication system;
acquiring the information based on signaling related to radio access network, RAN, notification area provisioning;
acquiring the information from the cell in which the small data transmission is to be performed by the user equipment;
acquiring the information from a last serving node which is a node of an access network of the cellular communication system, which served the user equipment before it transited to the inactive state;
acquiring the information in connection with acquiring a configuration of the small data transmission;
acquiring the information in connection with acquiring an RRC release message;
acquiring the information in connection with acquiring a suspend configuration,
wherein at least one out of the following applies:
the information indicates cells or areas of the cellular communication system out of RAN notification areas configured in the user equipment;
the information comprises cell identifiers;
the information comprises area identifiers;
the information comprises RAN area code identifiers;
the information comprises tracking area identifiers;
the information comprises closed area group identifiers;
the information comprises cell identifiers wherein a cell identifier identifies all cells of a serving node which controls the cells;
the information comprises area identifiers wherein an area identifier identifies all areas of a serving node which controls the areas.

27. The method of claim 24, the selecting comprising:
detecting whether or not the cell in which the small data transmission is to be performed by the user equipment is comprised in the information on areas acquired by the user equipment; and
in case the cell is comprised in the information of areas, selecting the second transmission method, and in case the cell is not comprised in the information on areas acquired by the user equipment, selecting the first transmission method.

28. The method of claim 21, further comprising:
deciding, at least based on the selected first or second transmission method, whether or not to use a protection function which protects data integrity for a data radio bearer associated with the small data transmission.

29. The method of claim 28, the deciding comprising:
deciding based on an instruction acquired from the cellular communication system, whether or not to use the protection function.

30. The method of claim 28, further comprising:
sending an indication from a radio resource control, RRC, protocol layer of the user equipment to a packet data convergence protocol, PDCP, layer of the user equipment, to apply or not apply the protection function based on a decision whether or not to use the protection function.

31. The method of claim 28, further comprising:
based on a decision whether or not to use the protection function,
sending an indication from a radio resource control, RRC, protocol layer of the user equipment to a first entity of a packet data convergence protocol, PDCP, layer of the user equipment, wherein the first entity is associated with a data radio bearer without integrity protection for which the protection function is not applied, wherein the data radio bearer without integrity protection is associated with the small data transmission, or
sending an indication from the RRC protocol layer of the user equipment to a second entity of the PDCP layer of the user equipment, wherein the second entity is associated with a data radio bearer with integrity protection for which the protection function is applied, wherein the data radio bearer with integrity protection is associated with the small data transmission.

32. The method of claim 30, the sending comprising:
sending the indication on a per payload or packet data unit basis within the small data transmission, or
sending the indication for the small data transmission.

33. The method of claim 28, the deciding comprising at least one of the following:
deciding to use the protection function in case the second transmission method is selected and deciding not to use the protection function in case the first transmission method is selected;
deciding to use the protection function in case the first or second transmission method is selected.

34. The method of claim 28, further comprising at least one of the following:
receiving, in response to the small data transmission performed by the second transmission method, a request from the cellular communication network to change a key used by the protection function, wherein the request is based on the first transmission method; or
switching the second transmission method to the first transmission method for performing a subsequent small data transmission after performing a predetermined number of small data transmissions by the second transmission method, and, in response to the switching, receiving a request from the cellular communication network to change a key used by the protection function, wherein the request is based on the first transmission method.

35. A method for use by an apparatus of a cellular communication system, the method comprising:
providing information of cells or areas of the cellular communication system, wherein the information indicates that, for a small data transmission to be performed by a user equipment in case the user equipment is in an inactive state, a first or second transmission method is to be applied in the cells or areas.

36. The method of claim 35, wherein
the apparatus comprises a serving node of an access network of the cellular communication system, which controls the cell,
the apparatus comprises a distributed unit and a centralized unit, and wherein
the second transmission method comprises stateless routing between the distributed unit and the centralized unit.

37. The method of claim 35, the providing comprising at least one of the following:
providing the information based on signaling related to radio access network, RAN notification area provisioning;
providing the information in connection with providing a configuration of the small data transmission;
providing the information in connection with providing an RRC release message;
providing the information in connection with providing a suspend configuration,
wherein at least one out of the following applies:
the apparatus is a last serving node which is a node of an access network of the cellular communication system, which served the user equipment before it transited to the inactive state,
the information indicates cells or areas of the cellular communication system out of RAN notification areas configured in the user equipment;
the information comprises cell identifiers;
the information comprises area identifiers;
the information comprises RAN area code identifiers;
the information comprises tracking area identifiers;
the information comprises closed area group identifiers;
the information comprises cell identifiers wherein a cell identifier identifies all cells of a serving node which controls the cells; or
the information comprises area identifiers wherein an area identifier identifies all areas of a serving node which controls the areas.

38. The method of claim 35, further comprising:
providing an instruction to the user equipment whether or not to use a protection function which protects data integrity for a data radio bearer associated with the small data transmission.

39. The method of claim 38, wherein the instruction is associated with the first or second transmission method which is to be applied in the cells or areas.

40. The method of claim 35, further comprising at least one of the following:
transmitting, in response to the small data transmission performed by the second transmission method, a request to the user equipment to change a key used by the protection function, using the first transmission method; or
transmitting, in response to the user equipment switching the second transmission method to the first transmission method for performing the small data transmission after performing a predetermined number of small data transmissions by the second transmission method, a request to the user equipment to change a key used by the protection function, using the first transmission method.

41. A non-transitory computer-readable storage medium that stores a program that when executed by a computer causes the computer at least to perform the method of claim 21.

42. A non-transitory computer-readable storage medium that stores a program that when executed by a computer causes the computer at least to perform the method of claim 35.
